(19) United States
(12) Patent Application Publication
(10) Pub. No.: US 2026/0191219 A1
(43) Pub. Date: Jul. 9, 2026

(54) FORMULATIONS FOR HIGH-PROTEIN, NON-DAIRY CHEESE ANALOG

(71) Applicant: ARBIOM SAS, Paris (FR)

(72) Inventors: Ricardo EKMAY, Morrisville, NC (US); Alana BERTELSEN, Foster City, CA (US); Doug BERG, Foster City, CA (US); Barb STUCKEY, Foster City, CA (US); Erin McGLOTHLIN, Foster City, CA (US); Luke TATTI, Foster City, CA (US)

(21) Appl. No.: 19/128,379

(22) PCT Filed: Nov. 10, 2023
(86) PCT No.: PCT/EP2023/081510

§ 371 Date: May 8, 2025

Related U.S. Application Data
(60) Provisional application No. 63/383,094, filed on Nov. 10, 2022.

(51) Int. Cl. A23C 20/02; A23L 23/00

(52) U.S. Cl. CPC A23C 20/025; A23C 20/02; A23L 23/00

(57) ABSTRACT

The invention is based on a non-dairy cheese product composition, wherein the quantity of crude protein in the non-dairy cheese product composition is at least about 4 wt. %, or between about 4 wt. % and 20 wt. %, and wherein the non-dairy cheese product composition comprises an inactive yeast source, wherein the quantity of the inactive yeast source in the non-dairy cheese product composition is at least about 5 wt. %, at least about 10 wt. %, or between about 5 wt. % and 25 wt. %. The invention further provides a non-dairy cheese product, obtainable from a non-dairy cheese product composition according to this invention, wherein the non-dairy cheese product is a hard or a semi-hard cheese, such as a parmesan cheese, a cheddar cheese, a gouda cheese, or an aged gouda cheese, or wherein the non-dairy cheese product is a non-dairy cheese sauce. The invention also pertains to the use of an inactive yeast source in a non-dairy cheese product composition, wherein the quantity of the inactive yeast source in the non-dairy cheese product composition is at least about 5 wt. %, to increase the protein content in the non-dairy cheese product by facilitating the inclusion of a plant and/or a microbial protein concentrate or isolate in the non-dairy cheese product composition.

### FIELD OF THE INVENTION

The invention is based on a non-dairy cheese product composition, wherein the quantity of crude protein in the non-dairy cheese product composition is at least about 4 wt. %, or between about 4 wt. % and 20 wt. %, and wherein the non-dairy cheese product composition comprises an inactive yeast source, wherein the quantity of the inactive yeast source in the non-dairy cheese product composition is at least about 5 wt. %, at least about 10 wt. %, or between about 5 wt. % and 25 wt. %. The invention further provides a non-dairy cheese product, obtainable from a non-dairy cheese product composition according to this invention, wherein the non-dairy cheese product is a hard or a semi-hard cheese, such as a parmesan cheese, a cheddar cheese, a gouda cheese, or an aged gouda cheese, or wherein the non-dairy cheese product is a non-dairy cheese sauce. The invention also pertains to the use of an inactive yeast source in a non-dairy cheese product composition, wherein the quantity of the inactive yeast source in the non-dairy cheese product composition is at least about 5 wt. %, to increase the protein content in the non-dairy cheese product by facilitating the inclusion of a plant and/or a microbial protein concentrate or isolate in the non-dairy cheese product composition.

### DESCRIPTION

Non-dairy cheese products are a category of foods developed for consumers that have allergenicity to dairy proteins or an intolerance to lactose (milk sugars). Alternatively, many consumers have a desire for animal-free products for ethical and/or sustainability concerns (e.g., vegans), and recently there has been an increasing trend in the supply of dairy-free products. Moreover, the general public has become aware of the need to control the intake of animal fats and cholesterol in their diets for health reasons, since many medical studies have concluded that human consumption of animal fats and cholesterol should be limited to avoid maladies like coronary heart disease. Since dairy cheese products are regarded as a significant source of saturated animal fats and cholesterol, the general recommendation has thus been to greatly reduce or even eliminate consumption of dairy cheese products. This recommendation is rapidly becoming accepted by the public and is resulting in a substantial decrease in the consumption of dairy-containing cheese food products.

For many consumers, health and sustainability (including animal welfare and environmental footprint) are thus core motivators for their choice of a non-dairy (i.e., dairy-free) diet, including, e.g., non-dairy milk and non-dairy cheese.

Non-dairy cheese products are typically composed of water, a starch, an oil, and various additives (such as thickeners, gelling agents, preservatives, stabilizers, emulsifiers, hydrocolloids, whitening agents, plasticizers, and/or anti-caking agents). Methods for producing non-dairy cheese products through combination of water, starch, oil, and various additives are well-known to the person skilled in the art.

A further method for producing non-dairy cheese is the fermentation of nuts and/or nut milks, such as cashew milk, coconut milk, hazelnut milk, and/or walnut milk.

Unfortunately, the use of plant proteins as a source of protein in non-dairy cheese products is limited due to “off” flavors and textures that confer to the product. For example, soy and pea protein may confer a beany taste and/or a gritty texture. Such “off” flavors are often masked by odors and/or flavors, which may require labelling of such compounds, which is also unattractive in view of the generally health-conscious consumer market for non-dairy cheese products.

WO 2021/080969 A1 discloses high protein analog cheese using pea starch and methods for making such analog cheese.

WO 2020/089383 A1 discloses non-dairy cheese analogues and processes for preparation thereof.

WO 2017/150973 A1 relates to vegan cheese analogues.

However, many commercial non-dairy cheese products are devoid or low in protein (<1 g/28 g, i.e. <4 wt. %), whereas dairy-based cheeses typically contain around 20% protein content. Unfortunately, saturated fats and high levels of cholesterol are commonly found in food products with an animal origin, such as dairy products. However, despite the desire to lower the intake of animal fats and cholesterol in the diet for health reasons, dairy products are commonly still recommended as part of a healthy diet by many regulatory agencies (such as based on FDA definitions), because of their high protein content and thus being a good source of protein. Therefore, there is a need for a non-dairy cheese product composition containing a high amount of protein, and yet having desirable textural properties.

Thus, it is an object of the invention to provide a formulation for producing a non-dairy cheese product containing greater than 1 g of crude protein per 28 g serving. It is a further object of the invention to provide a non-dairy cheese product composition for producing a non-dairy cheese product, wherein the quantity of crude protein in the non-dairy cheese product composition is at least about 4 wt. %. It is yet another object of the invention to provide a method for producing a non-dairy cheese product containing greater than about 4% crude protein by weight.

### BRIEF DESCRIPTION OF THE INVENTION

Generally, and by way of brief description, the main aspects of the present invention can be described as follows:

In a first aspect, the invention pertains to a non-dairy cheese product composition, wherein the quantity of crude protein in the non-dairy cheese product composition is at least about 4 wt. %, at least about 10 wt. %, at least about 15 wt. %, or between about 4 wt. % and 20 wt. %, and wherein the non-dairy cheese product composition comprises an inactive yeast source, wherein the quantity of the inactive yeast source in the non-dairy cheese product composition is at least about 5 wt. %, at least about 10 wt. %, at least about 15 wt. %, at least about 20 wt. %, or between about 5 wt. % and 25 wt. %.

In a second aspect, the invention pertains to a non-dairy cheese product, obtainable from a non-dairy cheese product composition according to the first aspect of this invention, wherein the non-dairy cheese product is a hard or a semi-hard cheese, such as a parmesan cheese, a cheddar cheese, a gouda cheese, or an aged gouda cheese, or wherein the non-dairy cheese product is a non-dairy cheese sauce.

In a third aspect, the invention pertains to a method for preparing a non-dairy cheese product composition according to the first aspect of this invention, or a non-dairy cheese product according to the second aspect of this invention.

In a fourth aspect, the invention pertains to a non-dairy cheese product composition or a non-dairy cheese product, obtainable by a method according to the third aspect of this invention.

In a fifth aspect, the invention pertains to the use of an inactive yeast source in a non-dairy cheese product composition, wherein the quantity of the inactive yeast source in the non-dairy cheese product composition is at least about 5 wt. %, at least about 10 wt. %, at least about 15 wt. %, at least about 20 wt. %, or between about 5 wt. % and 25 wt. % to increase the protein content in the non-dairy cheese product by facilitating the inclusion of a plant and/or a microbial protein concentrate or isolate in the non-dairy cheese product composition.

### DETAILED DESCRIPTION OF THE INVENTION

In the following, the elements of the invention will be described. These elements are listed with specific embodiments, however, it should be understood that they may be combined in any manner and in any number to create additional embodiments. The variously described examples and preferred embodiments should not be construed to limit the present invention to only the explicitly described embodiments. This description should be understood to support and encompass embodiments which combine two or more of the explicitly described embodiments or which combine the one or more of the explicitly described embodiments with any number of the disclosed and/or preferred elements. Furthermore, any permutations and combinations of all described elements in this application should be considered disclosed by the description of the present application unless the context indicates otherwise.

In the first aspect, the invention pertains to a non-dairy cheese product composition, wherein the quantity of crude protein in the non-dairy cheese product composition is at least about 4 wt. %, at least about 10 wt. %, at least about 15 wt. %, or between about 4 wt. % and 20 wt. %, and wherein the non-dairy cheese product composition comprises an inactive yeast source, wherein the quantity of the inactive yeast source in the non-dairy cheese product composition is at least about 5 wt. %, at least about 10 wt. %, at least about 15 wt. %, at least about 20 wt. %, or between about 5 wt. % and 25 wt. %.

According to the present invention, the term “non-dairy cheese product composition” refers to a formulation for producing a non-dairy cheese product. The terms “non-dairy cheese product composition”, and “formulation for producing a non-dairy cheese product” can be used interchangeably. According to the present invention, the “non-dairy cheese product composition” also refers to a formulation for producing a cheese analogue. The terms “cheese analogue” and “non-dairy cheese product” can be used interchangeably. Cheese analogues may be defined as products in which individual constituents, including non-dairy fats and/or proteins are formulated to produce a cheese-like product.

As used herein, the term “non-dairy cheese composition” refers to a non-dairy composition used to make a non-dairy cheese product or the final product of a non-dairy cheese itself. For example, the term “non-dairy cheese composition” could refer to a composition during one or more stages of the manufacturing of the non-dairy cheese, such as when certain non-dairy cheese composition ingredients are being mixed together. As another example, the term “non-dairy cheese composition” could refer to a mixture of non-dairy cheese ingredients being mixed and heated. Or, as yet another example, the term “non-dairy cheese composition” could refer to a composition that is in the form of a final non-dairy cheese product, ready to be sold for human consumption (e.g., the non-dairy cheese composition could be in the form of non-dairy shredded cheese, non-dairy sliced cheese, a non-dairy cheese sauce, or combinations thereof).

In one embodiment, the non-dairy cheese product composition contains greater than about 4% crude protein by weight, or greater than about 10% crude protein by weight, or greater than about 15%, or from 4% to 20%.

The inventors surprisingly found that the inclusion of an inactive yeast source in the non-dairy cheese product composition of at least about 5 wt. % in the non-dairy cheese product composition is a source of quantifiable protein itself, and additionally facilitates an enhanced inclusion of plant or microbial proteins. Moreover, the inclusion of an inactive yeast source in the non-dairy cheese product composition of at least about 5 wt. % in the non-dairy cheese product composition facilitates the enhanced inclusion of plant or microbial proteins through flavor enhancement and/or texture enhancement, and/or provides an emulsifying property. Moreover, the inclusion of an inactive yeast source in the non-dairy cheese product composition of at least about 5 wt. % in the non-dairy cheese product composition reduces the need for additional flavorings, flavor enhancers, proteins, and/or emulsifying salts. Thus, the non-dairy cheese product composition according to the present invention is high in protein content and yet low in saturated fat and/or cholesterol, and additionally has desirable textural properties similar to dairy cheese.

The present invention also relates to the non-dairy cheese product composition according to the first aspect of this invention, wherein the non-dairy cheese product composition comprises at least 1 g of crude protein per 28 g serving, or at least about 2 g of crude protein per 28 g serving, or at least about 3 g of crude protein per 28 g serving, or from about 1 g to 6 g of crude protein per 28 g serving.

In one embodiment, the non-dairy cheese product composition contains greater than 1 g of crude protein per 28 g serving, or greater than about 2 g of crude protein per 28 g serving, or greater than about 3 g of crude protein per 28 g serving, or from about 1 g to 6 g of crude protein per 28 g serving.

According to the present invention, any kind of inactive yeast source can be used. In a preferred embodiment, the inactive yeast source is selected from any one of brewer's yeast, dried yeast, torula yeast, yeast extracts, autolyzed yeast, and yeast cultivated on a substrate, such as yeast cultivated on a lignocellulosic substrate, and combinations thereof.

According to the present invention, inactivation of yeast typically occurs through thermal inactivation. Thermal inactivation can be achieved through a pasteurization-like step. However, according to the present invention, during this “pasteurization-like step”, the temperature does not need to be as high as typical pasteurization temperatures, which are well known to the person of skill, if the only purpose is yeast inactivation. The yeast inactivation step can occur prior to drying or during the drying process (such as by spray drying or drum drying). However, according to the present invention, drying is not a necessary step. Other methods of inactivation of yeast include autolysis and enzymatic hydrolysis. The extent of inactivation may depend on the specific functionalities that the manufacturer wishes to retain within the yeast product. As an example, a minimal heat application may be applied to only kill the yeast. Contrary, a combination of heat and specific enzymes may be used to kill the yeast and fractionate the cell wall in specific ways to elicit desired functions of the inactivated yeast.

In one embodiment, yeast sources are included at a rate greater than about 5%, at a rate greater than about 10%, at a rate greater than about 15%, at a rate greater than about 20%, and a rate in between 5% and 25%.

In one embodiment, the non-dairy cheese product composition is a vegan non-dairy cheese product composition.

In one embodiment relating to the non-dairy cheese product composition according to the first aspect of this invention, the non-dairy cheese product composition comprises an oil source or a combination of oil sources, wherein the quantity of the oil source or the combination of oil sources in the non-dairy cheese product composition is at least about 15 wt. %, at least about 25 wt. %, at least about 35 wt. %, or between about 15 wt. % and 40 wt. %.

The amount and/or type of the oil source used in the non-dairy cheese product composition of the present invention will depend on the functional characteristics required for the non-dairy cheese product composition and/or non-dairy cheese product. In one embodiment, the oil source is included at a rate greater than about 15%, at a rate greater than about 25%, at a rate greater than about 35%, and at a rate in between 15 and 40% of the product by weight.

According to the present invention, any kind of oil source can be used. In one embodiment, the oil source is selected from any one of coconut oil, sunflower oil, rapeseed oil, and combinations thereof.

In one embodiment relating to the non-dairy cheese product composition according to the first aspect of this invention, the non-dairy cheese product composition comprises a polysaccharide source or a combination of polysaccharide sources, wherein the quantity of the polysaccharide source or the combination of polysaccharide sources in the non-dairy cheese product composition is at least about 5 wt. %, at least about 15 wt. %, at least about 25 wt. %, or between about 5 wt. % and 30 wt. %.

According to the present invention, the term “polysaccharide”, as used herein, refers to any chain of sugar moieties including those of glucose, xylose, galactose, mannose, etc. Polysaccharides may have several functionalities including, but not limited to, thickening agents, emulsifiers, and stabilizers. The term “polysaccharides” as used herein refers to starches and/or gums depending on their nature. According to this invention, the terms “polysaccharide”, “starch” and “gum” can be used interchangeably. Polysaccharide/starch/gum sources that can be used for the present invention include, but not limited to, modified potato starch, modified corn starch, tapioca flour, modified sago starch, potato starch, locust bean gum, and xanthan gum.

The polysaccharide/starch used in the present invention may be a native polysaccharide/starch or a modified polysaccharide/starch. The term “native polysaccharide/starch” means that the polysaccharide/starch has not been modified. However, polysaccharides/starches may be modified to provide a variety of technical functions, including reducing or increasing the viscosity of the polysaccharide/starch solution and/or increasing the stability of the polysaccharide/starch solutions during cooking, shearing, cold storage or the freeze/thaw cycle.

Modifications of polysaccharides/starches involve cross-linking, stabilization, oxidation, or combinations thereof. Cross-linking is the process of connecting two starch molecular chains with a chemical agent, such as phosphorous oxychloride, sodium trimetaphosphate or adipic anhydride. Cross-linking can be performed for the purpose of stabilizing the granules to lower the viscosity and/or to increase the stability of the polysaccharides/starches. Stabilization is a modification where the cross-linked polysaccharides/starches is rendered stable to low temperatures, such as those of a refrigerator or a freezer, by the use of chemical reagents, such as succinic anhydride, octenylsuccinic anhydride, acetic anhydride, sodium orthophosphate, potassium orthophosphate, sodium tripolyphosphate, or potassium tripolyphosphate. Oxidation of an aqueous polysaccharide/starch solution with, e.g., sodium hypochlorite, can reduce the viscosity, resulting in a stable and/or clear solution.

The polysaccharide/starch used in the present invention is preferably granular in structure. This means that the polysaccharide/starch is not subject to a pregelatinization step, in which the starch is cooked in water and subsequently dried. The term “granular” means that the polysaccharide/starch has substantially retained or completely retained its granular structure and has not been pre-cooked. The terms “granular polysaccharide”/“granular starch” and “pregelatinized polysaccharide”/“pregelatinized starch” are well-known to those of ordinary skill in the art. The preferred polysaccharide/starch of the present invention is not pregelatinized.

Starches can be used as polysaccharide source in the non-dairy cheese product composition of the present invention. Non-starch carbohydrates can further be used as fillers. Such fillers do not provide any particular functional characteristics other than bulk. Preferred non-starch carbohydrates include corn syrup, dextrose, sucrose, lactose, maltose, maltodextrin, and combinations thereof.

The amount and/or type of the polysaccharide/starch source used in the non-dairy cheese product composition of the present invention will depend on the functional characteristics required for the non-dairy cheese product composition and/or non-dairy cheese product. In one embodiment, the polysaccharide/starch source is included at a rate greater than about 5%, greater than about 15%, greater than about 25%, and at a rate in between 5 and 30% of the product by weight.

According to the present invention, any kind of polysaccharide source can be used. In one embodiment, the polysaccharide source is selected from any one of a chain of sugar moieties, such as a chain of glucose moieties, a chain of xylose moieties, a chain of galactose moieties, or a chain of mannose moieties, modified potato starch, modified corn starch, tapioca flour, modified sago starch, potato starch, locust bean gum, xanthan gum, and combinations thereof.

In one embodiment relating to the non-dairy cheese product composition according to the first aspect of this invention, the non-dairy cheese product composition comprises a plant and/or a microbial protein concentrate or isolate, wherein the quantity of the plant and/or the microbial protein concentrate or isolate in the non-dairy cheese product composition is between about 0.0 wt. % and 20.0 wt. %, or between about 0.0 wt. % and 15.0 wt. %, or between about 0.0 wt. % and 10.0 wt. %, or between about 0.1 wt. % and 10.0 wt. %.

The amount and/or type of the plant or microbial protein concentrate or isolate used in the non-dairy cheese product composition of the present invention will depend on the functional characteristics required for the non-dairy cheese product composition and/or non-dairy cheese product. In one embodiment, the non-dairy cheese product includes a plant or microbial protein concentrate or isolate between 0 and 20%, preferably between 0 and 10% of the product by weight.

According to the present invention, any kind of plant and/or the microbial protein concentrate or isolate can be used. In one embodiment, the plant and/or the microbial protein concentrate or isolate is derived from soybeans, corn, peas, canola seeds, sunflower seeds, rice, amaranth, lupin, rape seeds, or mixtures thereof. In one embodiment, the plant and/or the microbial protein concentrate or isolate is selected from a soy protein concentrate, a soy protein isolate, a pea protein isolate, a chickpea concentrate, mycoprotein, and combinations thereof.

Processes for making plant and/or microbial protein concentrates or isolates are well known to the person of skill. As an example, a process for making soy protein isolates is as follows. Soybeans which are characterized by being sound, mature, and yellow soybeans, enter a processing plant, and the soybeans can subsequently be washed to remove dirt and/or small stones. The soybeans are typically screened to remove damaged beans and foreign materials, and may be sorted to uniform size. Each cleaned raw soybean is then cracked into several pieces, typically six (6) to eight (8), to produce soy chips and hulls. The hulls are removed by aspiration. Alternatively, the hulls may be loosened by adjusting the moisture level and mildly heating the soybeans before cracking. Hulls can also be removed by passing cracked pieces through corrugated rolls revolving at different speeds. In these methods, the hulls are then removed by a combination of shaker screen and aspiration. The soy chips, which typically contain about 11% moisture, are then heated to about 60° C. and flaked into flakes, which typically have about 0.25 millimeter thickness. The resulting flakes are then extracted with an inert solvent, such as a hydrocarbon solvent, typically hexane, in one of several types of countercurrent extraction systems to remove the soybean oil.

The flakes are then desolventized in a manner which minimizes the amount of cooking or toasting of the soy protein to preserve a high content of water-soluble soy protein, which can be performed by using vapor desolventizers or flash desolventizers. The flakes resulting from this process are generally referred to as “edible defatted flakes”. The resulting edible defatted flakes, which are the starting material the soy protein isolate, have a protein content of approximately or greater than 50%. The edible defatted flakes can then be milled, usually in an open-loop grinding system, by a hammer mill, classifier mill, roller mill or impact pin mill. Screening is typically used to size the product to uniform particle size ranges, and can be accomplished with shaker screens or cylindrical centrifugal screeners. Subsequently, the soy protein is extracted from the edible defatted flakes with water or using a mixture having a pH of at least about 6.5 and preferably between about 7.0 and 10.0. The extract is then centrifuged to remove insoluble carbohydrates. A second extraction is performed on the insoluble carbohydrates to remove any additional soy protein. The second extract is centrifuged to give any further insoluble carbohydrates and a second aqueous extract. The first and second extracts are combined, and the insoluble carbohydrates are used to obtain the soy fiber.

The terms concentrate and isolate, as used herein, refer to a product whose protein content is greater than 50% crude protein by weight. In one embodiment, the protein content of the plant and/or the microbial protein concentrate or isolate is at least 50% crude protein by weight of the plant and/or the microbial protein concentrate or isolate.

In one embodiment relating to the non-dairy cheese product composition according to the first aspect of this invention, the inactive yeast source is a source of crude protein in the non-dairy cheese product composition.

In one embodiment, the inclusion of an inactive yeast source is a source of quantifiable protein.

In one embodiment relating to the non-dairy cheese product composition according to the first aspect of this invention, the inactive yeast source increases the protein content in the non-dairy cheese product by facilitating the inclusion of the plant and/or the microbial protein concentrate or isolate. The inventors surprisingly found that a moderately high inclusion rate of an inactive yeast (preferably >10%), increases the protein content of the product on its own but also increases the protein content by allowing for the use of plant and/or microbial protein concentrate or isolates without negative impact to flavor or consumer experience.

In one embodiment, the inclusion of an inactive yeast source facilitates the enhanced inclusion of plant or microbial proteins through flavor enhancement and/or texture enhancement.

In one embodiment, the inclusion of an inactive yeast source provides an emulsifying property.

In one embodiment, the inclusion of an inactive yeast source reduces the need for additional flavorings, flavor enhancers, proteins, and/or emulsifying salts.

In one embodiment relating to the non-dairy cheese product composition according to the first aspect of this invention, the non-dairy cheese product composition comprises a flavoring or a combination of flavorings, wherein the quantity of the flavoring or the combination of flavorings in the non-dairy cheese product composition is at least about 0.0 wt. %, at least about 0.5 wt. %, at least about 1 wt. %, at least about 1.5 wt. %, at least about 3.85 wt. %, or between about 0.0 wt. % and 5.0 wt. %.

In one embodiment relating to the non-dairy cheese product composition according to the first aspect of this invention, the non-dairy cheese product composition comprises a flavoring or a combination of flavorings, wherein the quantity of the flavoring or the combination of flavorings in the non-dairy cheese product composition is at least about 0.0 wt. %, at least about 0.5 wt. %, at least about 1 wt. %, at least about 1.5 wt. %, or between about 0.0 wt. % and 2.0 wt. %.

Flavors are well known to the person of skill and selected based on subjective preferences. The amount and/or type of flavorings used in the non-dairy cheese product composition of the present invention will depend on the characteristics required for the non-dairy cheese product composition and/or non-dairy cheese product. In one embodiment, flavorings are included at a rate greater than about 0%, greater than about 0.5%, greater than about 1%, greater than about 1.5%, and between 0 and 2% of the product by weight.

According to the present invention, any kind of flavoring can be used. In one embodiment, the flavoring is selected from a salt (such as sodium chloride), a cheese flavoring, such as cheese flavor parmesan type (Product code: 15001), parmesan cheese type (Product code: 11469D), or a dairy type flavor enhancer (Product code: 28293D), lactic acid, and combinations thereof.

In one embodiment, the non-dairy cheese product composition according to the first aspect of this invention comprises a flavoring, such as a flavoring selected from a salt (such as sodium chloride), a cheese flavoring, such as cheese flavor parmesan type (Product code: 15001), parmesan cheese type (Product code: 11469D), or a dairy type flavor enhancer (Product code: 28293D), and combinations thereof, in an amount between about 0.0 wt. % and 2.0 wt. %. In this embodiment, the non-dairy cheese product composition additionally comprises lactic acid in an amount between 0 and 2% of the product by weight. Of note, lactic acid brings the acidity needed for an accurate cheese flavor. Therefore, Lactobacillus is common in a cheese starter culture to achieve an accurate cheese flavor.

In one embodiment, the non-dairy cheese product composition comprises a salt for preservation reasons. An emulsifying salt, such as sodium hexameta-phosphate, sodium tripolyphosphate, tetrasodium pyrophosphate, trisodium phosphate or disodium phosphate, can be included in the non-dairy cheese product composition according to this invention.

In one embodiment relating to the non-dairy cheese product composition according to the first aspect of this invention, the non-dairy cheese product composition comprises a coloring or a combination of colorings, wherein the quantity of the coloring or the combination of colorings in the non-dairy cheese product composition is at least about 0.0 wt. %, at least about 0.5 wt. %, at least about 1 wt. %, at least about 1.5 wt. %, or between about 0.0 wt. % and 2.0 wt. %.

The amount and/or type of colorings used in the non-dairy cheese product composition of the present invention will depend on the functional characteristics required for the non-dairy cheese product composition and/or non-dairy cheese product. In one embodiment, colorings are included at a rate greater than 0%, greater than 0.5%, greater than 1%, greater than 1.5%, and between 0 and 2% of the product by weight.

According to the present invention, any kind of coloring can be used. Colorings are well known to the person of skill and selected based on subjective preferences. In one embodiment, the coloring is selected from annatto, paprika, and combinations thereof.

In one embodiment, which can be combined with all other embodiments and aspects of the present invention, the non-dairy cheese product composition comprises water and/or a plant-based milk, such as soy milk or oat milk. Water and/or the plant-based milk is typically added to the non-dairy cheese product composition of the present invention to obtain a quantity of 100% in total, i.e. q.s. water/plant-based milk for 100% total.

In one embodiment, which can be combined with all other embodiments and aspects of the present invention, the non-dairy cheese product composition comprises additives, such as thickeners, gelling agents, preservatives, stabilizers, emulsifiers, hydrocolloids, whitening agents, plasticizers, and/or anti-caking agents.

In another preferred embodiment, which can be combined with all other embodiments and aspects of the present invention, the non-dairy cheese product composition according to the first aspect of this invention comprises:
(i) Water and/or a plant-based milk, such as soy milk or oat milk;
(ii) An oil source, such as a coconut/sunflower oil blend;
(iii) A polysaccharide source, such as a modified food starch;
(iv) An inactive yeast source, such as torula yeast;
(v) Optionally, a plant and/or a microbial protein concentrate or isolate, such as a pea protein isolate;
(vi) A flavoring or a combination of flavorings, such as a salt, a dairy type flavor enhancer (Product code: 28293D), parmesan cheese type (Product code: 11469D), lactic acid, and/or cheese flavor parmesan type (Product code: 15001), and
(vii) A coloring or a combination of colorings, such as an annatto coloring.

In one embodiment, which can be combined with all other embodiments and aspects of the present invention, the non-dairy cheese product composition according to the first aspect of this invention comprises:
(i) Water and/or a plant-based milk, such as soy milk or oat milk, wherein the quantity of the water and/or the plant-based milk is between about 25 wt. % and 50 wt. %, preferably between about 35 wt. % and 40% wt. %, more preferably about 38% wt. %;
(ii) An oil source, wherein the quantity of the oil source is between about 15 wt. % and 40 wt. %, preferably between about 20 wt. % and 25% wt. %, more preferably about 23% wt. %, optionally wherein the oil source is a coconut/sunflower oil blend;
(iii) A polysaccharide source, wherein the quantity of the polysaccharide source is between about 5 wt. % and 30 wt. %, preferably between about 10 wt. % and 20 wt. %, more preferably about 17 wt. %, optionally wherein the polysaccharide source is modified food starch;
(iv) An inactive yeast source, wherein the quantity of the inactive yeast source is between about 5 wt. % and 25 wt. %, preferably between about 10 wt. % and 20 wt. %, more preferably about 14 wt. %, optionally wherein the polysaccharide source is torula yeast;
(v) Optionally, a plant and/or a microbial protein concentrate or isolate, wherein the quantity of the plant and/or the microbial protein concentrate or isolate is between about 0.00 wt. % and 10.00 wt. %, preferably between about 1.00 wt. % and 7.00 wt. %, more preferably about 4.00 wt. %, optionally wherein the plant and/or microbial protein concentrate or isolate is a pea protein isolate;
(vi) A flavoring or a combination of flavorings, wherein the quantity of the flavoring or the combination of flavorings is between about 0.00 wt. % and 5.00 wt. %, preferably between about 1.00 wt. % and 4.00 wt. %, more preferably about 3.85 wt. %, optionally wherein the combination of flavorings is a combination of a salt (such as sodium chloride), a dairy type flavor enhancer (Product code: 28293D), a parmesan cheese type (Product code: 11469D), lactic acid, and a cheese flavor parmesan type (Product code: 15001), and
(vii) A coloring or a combination of colorings, wherein the quantity of the coloring or a combination of colorings is between about 0.00 wt. % and 2.00 wt. %, preferably between about 0.01 wt. % and 0.10 wt. %, more preferably about 0.03 wt. %, optionally wherein the coloring or the combination of colorings is an annatto coloring.

In another preferred embodiment, which can be combined with all other embodiments and aspects of the present invention, the non-dairy cheese product composition according to the first aspect of this invention comprises:
(i) Water and/or a plant-based milk, such as soy milk or oat milk, wherein the quantity of the water and/or the plant-based milk is between about 25 wt. % and 50 wt. %, preferably between about 35 wt. % and 40% wt. %, more preferably about 38% wt. %;
(ii) an oil source, wherein the quantity of the oil source is between about 15 wt. % and 40 wt. %, preferably between about 20 wt. % and 25% wt. %, more preferably about 23% wt. %, optionally wherein the oil source is a coconut/sunflower oil blend;
(iii) a polysaccharide source, wherein the quantity of the polysaccharide source is between about 5 wt. % and 30 wt. %, preferably between about 10 wt. % and 20 wt. %, more preferably about 17 wt. %, optionally wherein the polysaccharide source is modified food starch;
(iv) an inactive yeast source, wherein the quantity of the inactive yeast source is between about 5 wt. % and 25 wt. %, preferably between about 10 wt. % and 20 wt. %, more preferably about 14 wt. %, optionally wherein the polysaccharide source is torula yeast;
(v) optionally, a plant and/or a microbial protein concentrate or isolate, wherein the quantity of the plant and/or the microbial protein concentrate or isolate is between about 0.00 wt. % and 10.00 wt. %, preferably between about 1.00 wt. % and 7.00 wt. %, more preferably about 4.00 wt. %, optionally wherein the plant and/or microbial protein concentrate or isolate is a pea protein isolate;
(vi) a flavoring or a combination of flavorings, wherein the quantity of the flavoring or the combination of flavorings is between about 0.00 wt. % and 2.00 wt. %, preferably between about 1.00 wt. % and 1.90 wt. %, more preferably about 1.75 wt. %, optionally wherein the flavoring or the combination of flavorings is the salt sodium chloride;
(vii) a flavoring or a combination of flavorings, wherein the quantity of the flavoring or the combination of flavorings is between about 0.0 wt. % and 1.2 wt. %, preferably between about 0.5 wt. % and 1.1 wt. %, more preferably about 1.0 wt. %, optionally wherein the flavoring or the combination of flavorings is a dairy type flavor enhancer (Product code: 28293D);
(viii) a flavoring or a combination of flavorings, wherein the quantity of the flavoring or the combination of flavorings is between about 0.0 wt. % and 0.7 wt. %, preferably between about 0.1 wt. % and 0.6 wt. %, more preferably about 0.5 wt. %, optionally wherein the flavoring or the combination of flavorings is a parmesan cheese type (Product code: 11469D);
(ix) a flavoring or a combination of flavorings, wherein the quantity of the flavoring or the combination of flavorings is between about 0.0 wt. % and 0.7 wt. %, preferably between about 0.1 wt. % and 0.6 wt. %, more preferably about 0.5 wt. %, optionally wherein the flavoring or the combination of flavorings is lactic acid;
(x) a flavoring or a combination of flavorings, wherein the quantity of the flavoring or the combination of flavorings is between about 0.00 wt. % and 0.60 wt. %, preferably between about 0.05 wt. % and 0.50 wt. %, more preferably about 0.10 wt. %, optionally wherein the flavoring or the combination of flavorings is a cheese flavor parmesan type (Product code: 15001), and
(xi) a coloring or a combination of colorings, wherein the quantity of the coloring or a combination of colorings is between about 0.00 wt. % and 2.00 wt. %, preferably between about 0.01 wt. % and 0.10 wt. %, more preferably about 0.03 wt. %, optionally wherein the coloring or the combination of colorings is an annatto coloring.

In the second aspect, the invention pertains a non-dairy cheese product, obtainable from a non-dairy cheese product composition according to the first aspect of this invention.

In one embodiment, the non-dairy cheese product according to the second aspect of this invention has the body, texture, ability (such as a springiness and/or stretch ability on baking) and/or eating qualities (such as mouth feel and/or creaminess) of natural dairy cheese.

In one embodiment, the non-dairy cheese product according to the second aspect of this invention is acceptable for consumers in terms of optimal textural attributes and/or a natural ingredient list.

Cheese and cheese products are highly nutritious and popular in a variety of prepared foods and snack items. Several categories of hard, semi-soft and soft cheeses exist. Natural cheeses, i.e., Cheddar, Mozzarella, Romano, Blue, Parmesan, Cream and the like, are produced without further processing or adding other ingredients, while pasteurized processed cheese entails further addition of ingredients and/or pasteurization. If a cheese does not comply with a standard identity and contains essentially similar components to a standard cheese, but chemical and/or physical properties (i.e. % fat, % moisture) exist outside common levels, the cheese may be referred to as a cheese product.

In one embodiment, the non-dairy cheese product is a very hard cheese product, such as parmesan or romano.

In one embodiment, the non-dairy cheese product is a hard cheese product, such as cheddar, mozzarella or provolone.

In one embodiment, the non-dairy cheese product is a semi-hard cheese, such as blue cheese.

In one embodiment, the non-dairy cheese product is a soft cheese, such as cream cheese or a spread.

In one embodiment, the non-dairy cheese product is one of a hard and semi-hard cheese type including, but not limited to, a parmesan cheese, a cheddar cheese, a gouda cheese, or an aged gouda cheese.

In one embodiment, the non-dairy cheese product is a non-dairy cheese sauce, wherein the non-dairy cheese product composition according to the first aspect of this invention comprises a non-dairy milk, such as oat milk or soy milk.

In one embodiment, the non-dairy milk is a plant-based milk, such as oat milk or soy milk. According to this invention, the terms “non-dairy milk” and “plant-based milk” can be used interchangeably.

In one embodiment, the non-dairy cheese product is a non-dairy cheese sauce, and the non-dairy cheese product composition comprises water and a plant-based milk.

In one embodiment relating to the second aspect of this invention, the non-dairy cheese product is a vegan non-dairy cheese product.

The preparation of non-dairy cheese products is conventional and well-known to those of ordinary skill in the art. Typically, all ingredients are mixed together, then heated for a short period of time, formed into a shape and finally refrigerated.

In the third aspect, the invention pertains a method for preparing a non-dairy cheese product composition according to the first aspect of this invention, or a non-dairy cheese product according to the second aspect of this invention, the method comprising the steps of:
(a) Heating an oil source to a temperature of from about 40° C. to about 70° C., or from about 45° C. to about 65° C., or from about 50° C. to about 60° C., or to about 55° C.,
(b) Pre-blending a polysaccharide source with an inactive yeast source, and optionally further with a plant and/or a microbial protein concentrate or isolate, to create a first blend;
(c) Combining the first blend with water and/or the plant-based milk, such as soy milk or oat milk, having a temperature of about 10° C. to about 30° C., or about 15° C. to about 25° C., or from about 18° C. to about 22° C., or about 20° C., to create a solution of the first blend;
(d) Heating the solution of the first blend to a temperature of from about 35° C. to about 60° C., or from about 40° C. to about 55° C., or from about 45° C. to about 50° C., or to about 49° C., and mixing the solution of the first blend at a first mixing rate to create a first mixture;
(e) Heating the first mixture to a temperature of from about 45° C. to about 75° C., or from about 50° C. to about 70° C., or from about 55° C. to about 65° C., or to about 60° C., adding a flavoring or a combination of flavorings, and/or a coloring or a combination of colorings, wherein the flavoring or the combination of flavorings, and/or the coloring or the combination of colorings, is in a dry state, and mixing at the first mixing rate to create a second mixture;
(f) Adding the heated oil source of step (a) to the second mixture to create a third mixture, and heating the third mixture to a temperature of from about 55° C. to about 85° C., or from about 60° C. to about 80° C., or from about 65° C. to about 75° C., or to about 71° C.;
(g) Optionally, adding a flavoring or a combination of flavorings, a coloring or a combination of colorings, wherein the flavoring or the combination of flavorings, and/or the coloring or the combination of colorings, is in a liquid state, and heating to a temperature of from about 80° C. to about 105° C., or from about 85° C. to about 100° C., or from about 90° C. to about 95° C., or to about 93° C.;
(h) Mixing at a second mixing rate, wherein the second mixing rate is higher than the first mixing rate, to create a fourth mixture;
(i) Transferring the fourth mixture to at least one mold to obtain a molded product and cooling the molded product to a temperature of from about −0.2° C. to about 16° C., or from about 0° C. to about 14° C., or from about 2° C. to about 12° C., or from about 4° C. to about 10° C., and
(j) Ripening of the molded product for at least one day, or for at least two days, or for at least three days, or for at least four days,
thereby obtaining a non-dairy cheese product composition or a non-dairy cheese product, wherein the quantity of crude protein in the non-dairy cheese product composition or the non-dairy cheese product is at least about 4 wt. %, at least about 10 wt. %, at least about 15 wt. %, or between about 4 wt. % and 20 wt. %.

In one embodiment relating to the method of the third aspect of this invention, the first mixing rate and the second mixing rate have a speed range of about 40 to about 3500 rpm, preferably of about 70 to about 3000 rpm, more preferably of about 100 to about 2000 rpm.

In another aspect, the invention pertains a method for preparing a non-dairy cheese product composition according to the first aspect of this invention, or a non-dairy cheese product according to the second aspect of this invention, the method comprising the steps of:
(a) Pre-blending a polysaccharide source with an inactive yeast source, and optionally further with a flavoring or a combination of flavorings, to create a first blend,
(b) Combining a plant-based milk, such as soy milk or oat milk, an oil source, such as canola oil, a liquid flavoring or a combination of flavorings, lactic acid and a coloring or a combination of colorings, to create a first mixture,
(c) Adding the first blend to the first mixture, to create a second mixture,
(d) Blending the second mixture to homogeneity to create a homogenous second mixture,
(e) Heating the homogenous second mixture to a temperature of from about 60° C. to about 110° C., or from about 70° C. to about 100° C., or from about 80° C. to about 90° C., or to about 85° C., and mixing the solution of the first blend at a first mixing rate to create a third mixture,
(f) Transferring the third mixture to at least one container, such as a package, a gable top or a pouch,
(g) Passing the at least one container of step (f) through a cooling tunnel or a rotating ice bath,
(h) Optionally, casing, palletizing and/or transferring the at least one container of step (g) to a refrigerated storage,
thereby obtaining a non-dairy cheese product, wherein the non-dairy cheese product is a non-dairy cheese sauce, and wherein the quantity of crude protein in the non-dairy cheese product is at least about 4 wt. %, at least about 10 wt. %, at least about 15 wt. %, or between about 4 wt. % and 20 wt. %.

In one embodiment, step b) of the method is performed in a steam kettle.

In one embodiment, the mixing in step e) is performed for 5 minutes.

In one embodiment, the transferring of the third mixture to the at least one container, such as the package, the gable top or the pouch, occurs, wherein the third mixture is transferred in a hot state.

In a fourth aspect, the present invention relates to a non-dairy cheese product composition or a non-dairy cheese product, obtainable by a method according to the third aspect of this invention.

In a fifth aspect, the present invention relates to the use of an inactive yeast source in a non-dairy cheese product composition, wherein the quantity of the inactive yeast source in the non-dairy cheese product composition is at least about 5 wt. %, at least about 10 wt. %, at least about 15 wt. %, at least about 20 wt. %, or between about 5 wt. % and 25 wt. % to increase the protein content in the non-dairy cheese product by facilitating the inclusion of a plant and/or a microbial protein concentrate or isolate in the non-dairy cheese product composition.

The inventors surprisingly found that the use of an inactive yeast source in a quantity of at least about 5 wt. % in the non-dairy cheese product composition increases the protein content of the non-dairy cheese product composition and/or the non-dairy cheese product on its own but also increases the protein content of the non-dairy cheese product composition and/or the non-dairy cheese product by allowing for the use of plant and/or microbial protein concentrate or isolates without negative impacting the flavor or consumer experience. The inventors further found that the use of an inactive yeast source in a quantity of at least about 5 wt. % in the non-dairy cheese product composition facilitates the enhanced inclusion of plant or microbial proteins through flavor enhancement and/or texture enhancement, and/or provides an emulsifying property. Moreover, the inclusion of an inactive yeast source in the non-dairy cheese product composition of at least about 5 wt. % in the non-dairy cheese product composition reduces the need for additional flavorings, flavor enhancers, proteins, and/or emulsifying salts. Thus, by using an inactive yeast source in a non-dairy cheese product composition, wherein the quantity of the inactive yeast source in the non-dairy cheese product composition is at least about 5 wt. %, at least about 10 wt. %, at least about 15 wt. %, at least about 20 wt. %, or between about 5 wt. % and 25 wt. %, the protein content of a non-dairy cheese product composition according to the present invention is increased, to generate a non-dairy cheese product that has a high protein content (at least 1 g/28 g serving, i.e. at least 4 wt. %), but is yet low in saturated fat and/or cholesterol, and additionally has desirable textural properties similar to dairy cheese.

The terms “of the [present] invention”, “in accordance with the invention”, “according to the invention” and the like, as used herein are intended to refer to all aspects and embodiments of the invention described and/or claimed herein.

As used herein, the term “comprising” is to be construed as encompassing both “including” and “consisting of”, both meanings being specifically intended, and hence individually disclosed embodiments in accordance with the present invention. Where used herein, “and/or” is to be taken as specific disclosure of each of the two specified features or components with or without the other. For example, “A and/or B” is to be taken as specific disclosure of each of (i) A, (ii) B and (iii) A and B, just as if each is set out individually herein. In the context of the present invention, the terms “about” and “approximately” denote an interval of accuracy that the person skilled in the art will understand to still ensure the technical effect of the feature in question. The term typically indicates deviation from the indicated numerical value by ±20%, ±15%, ±10%, and for example ±5%. As will be appreciated by the person of ordinary skill, the specific such deviation for a numerical value for a given technical effect will depend on the nature of the technical effect. For example, a natural or biological technical effect may generally have a larger such deviation than one for a man-made or engineering technical effect. As will be appreciated by the person of ordinary skill, the specific such deviation for a numerical value for a given technical effect will depend on the nature of the technical effect. For example, a natural or biological technical effect may generally have a larger such deviation than one for a man-made or engineering technical effect. Where an indefinite or definite article is used when referring to a singular noun, e.g. “a”, “an” or “the”, this includes a plural of that noun unless something else is specifically stated.

It is to be understood that application of the teachings of the present invention to a specific problem or environment, and the inclusion of variations of the present invention or additional features thereto (such as further aspects and embodiments), will be within the capabilities of one having ordinary skill in the art in light of the teachings contained herein.

Unless context dictates otherwise, the descriptions and definitions of the features set out above are not limited to any particular aspect or embodiment of the invention and apply equally to all aspects and embodiments which are described.

All references, patents, and publications cited herein are hereby incorporated by reference in their entirety.

### BRIEF DESCRIPTION OF THE FIGURES

The figures show:

FIG. 1 shows a scheme of a process of making a non-dairy cheese product composition according to this invention.

FIG. 2 shows a scheme of a process of making a non-dairy cheese sauce according to this invention.

### EXAMPLES

Certain aspects and embodiments of the invention will now be illustrated by way of example and with reference to the description, figures and tables set out herein. Such examples of the methods, uses and other aspects of the present invention are representative only, and should not be taken to limit the scope of the present invention to only such representative examples.

The examples show:

### Example 1—Non-Dairy Aged Gouda Cheese

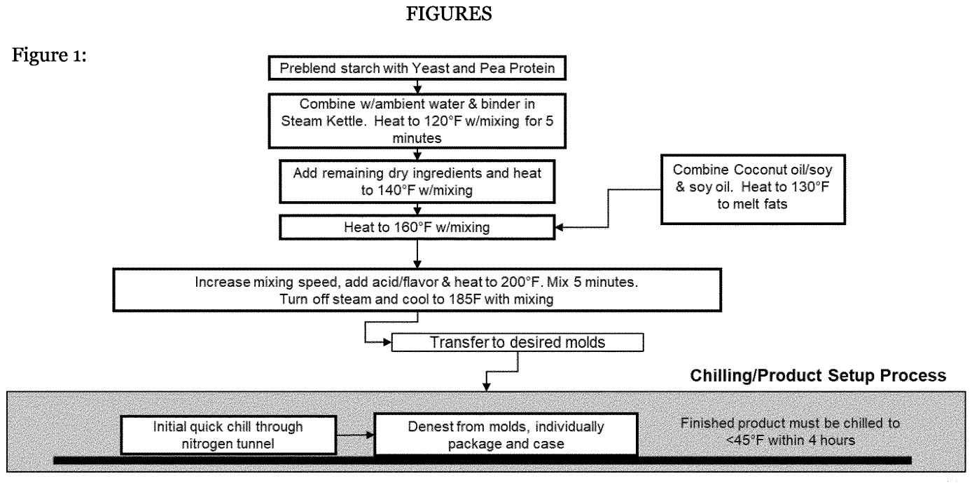

A general process of making a non-dairy cheese product composition according to the first aspect of this invention, or a non-dairy cheese product according to the second aspect of this invention, is as follows and is shown in FIG. 1.

A non-dairy aged gouda was prepared following the recipe in Table 1, i.e. using 38% water, 23% coconut/sunflower oil blend, 17% modified food starch, 14% torula yeast, 4% pea protein isolate, 1.75% salt (sodium chloride), 1% dairy type flavor enhancer (Product code: 28293D), 0.5% parmesan cheese type (Product code: 11469D), 0.5% lactic acid, 0.1% cheese flavor parmesan type (Product code: 15001), and 0.03% annatto color. The resulting aged gouda cheese contains 3 g of protein per 28 g serving size.

Coconut/sunflower oil is first weighed into a container, which is then covered and placed in a warm water bath having a temperature of from about 40° C. to about 70° C., or from about 45° C. to about 65° C., or from about 50° C. to about 60° C., to about 55° C. (130° F.) to melt oil.

Starch and protein is then pre-blended and set aside.

The remaining dry ingredients, such as salt and dry flavors, are then pre-blended and set aside.

Subsequently, room temperature water having a temperature of about 10° C. to about 30° C., or about 15° C. to about 25° C., or about 18° C. to about 22° C., or about 20° C. (68° F.) is weighed into a Thermomix.

The starch/protein blend is added, and the Thermomix mixer is set to Speed 3, and a temperature of from about 35° C. to about 60° C., or from about 40° C. to about 55° C., or from about 45° C. to about 50° C., or about 49° C. (120° F.), followed by mixing for 5 minutes.

With thermomixer at Speed 3, and having a temperature of from about 45° C. to about 75° C., or from about 50° C. to about 70° C., or from about 55° C. to about 65° C., or about 60° C. (140° F.), the remaining dry ingredients are added through lid opening and mixed for 2 minutes.

Subsequently, the melted coconut/sunflower oil blend is added in a thin stream and the temperature is increased to a temperature of from about 50° C. to about 100° C., or from about 60° C. to about 90° C., or from about 70° C. to about 80° C., or to about 71° C. (160° F.), followed by mixing for 2 minutes.

The Thermomix is then stopped and the sides of the Thermomix are scraped down.

The mixer speed is then set to Speed 4.5, and the temperature is increased to a temperature of from about 80° C. to about 105° C., or from about 85° C. to about 100° C., or from about 90° C. to about 95° C., or to about 93° C. (200° F.). Then, lactic acid, liquid flavors, and colors are slowly poured in, and mixed for 5 minutes.

Subsequently, the Thermomix is stopped, and the temperature checked, wherein the target temperature is greater than a temperature of from about 60° C. to about 110° C., or from about 70° C. to about 100° C., or from about 80° C. to about 90° C., or to about 85° C. (185° F.).

The product is then transferred to molds. The container is covered and placed in an ice water bath for 60 minutes. A temperature check is required, wherein the temperature must be below a temperature of from about −0.2° C. to about 16° C., or from about 0° C. to about 14° C., or from about 2° C. to about 12° C., or from about 4° C. to about 10° C. (or around 45° F.) within 4 hours. The cheese is then allowed to age for 4 days.

The crude protein content of the resulting cheese is around 10.9%, or around 3 g per serving.

The product can subsequently be sliced and/or shredded. Alternatively, the product may be filled into small loaves for use by the consumer. The product may also be extruded into wrapped, single sliced forms.

TABLE 1
Non-dairy aged gouda recipe

| Ingredient | Supplier | Percent |
|---|---|---|
| Water | Municipal | 38.12 |
| Coconut/sunflower oil blend | AAK USA | 23.00 |
| Modified food starch | TIC Gums | 17.00 |
| Torula yeast | Arbiom | 14.000 |
| Pea protein isolate | Puris | 4.00 |
| Salt (sodium chloride) | Cargill | 1.75 |
| Dairy type flavor enhancer | First Choice | 1.00 |
| (Product code: 28293D) | Ingredients | |
| Parmesan cheese type | First Choice | 0.50 |
| (Product code: 11469D) | Ingredients | |
| Lactic acid | Corbion | 0.50 |
| Cheese flavor parmesan type | First Choice | 0.10 |
| (Product code: 15001) | Ingredients | |
| Annatto color | Sensient | 0.03 |
| Total | | 100.00 |

A person of ordinary skill in the art has the ability to use the preceding formulations to produce a non-dairy cheese product of the desired type through refinement of the relative percentages of the formulation reported herein.

### Example 2—Non-Dairy Cheese Sauce

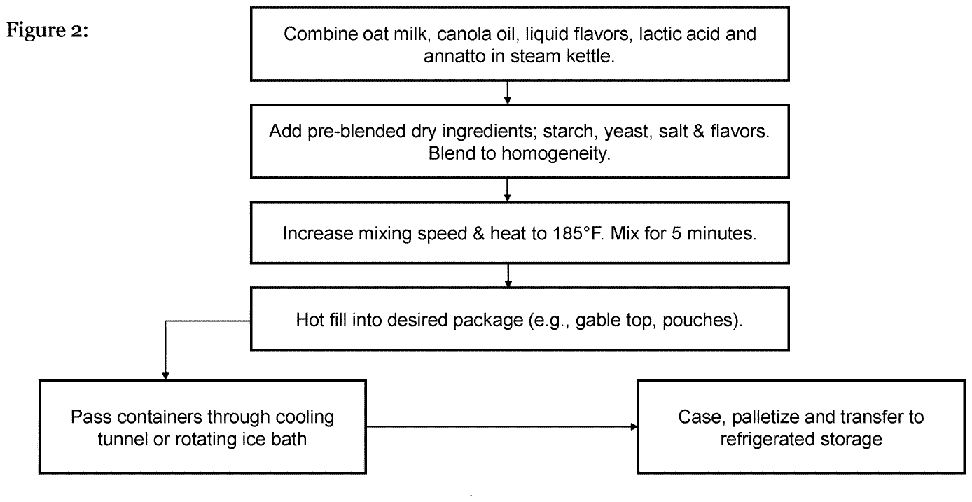

A general process of making a non-dairy cheese sauce according to this invention is shown in FIG. 2.

TABLE 2
Cheese Sauce Recipe

| Ingredient | Supplier | Percent |
|---|---|---|
| Oat milk, full fat | Oatly | 61.75 |
| Canola oil | AAK USA | 18.00 |
| Torula yeast | Arbiom | 14.00 |
| Modified tapioca starch (N | Ingredion | 2.50 |
| Dulge) | | |
| Salt | Cargill | 1.50 |
| Dairy type flavor enhancer | First Choice | 1.00 |
| (Product code: 28293D) | Ingredients | |
| Natural cheddar type flavor | First Choice | 0.75 |
| (Product code: 12292D) | Ingredients | |
| Lactic acid | Corbion | 0.35 |
| Natural mild gouda cheese | First Choice | 0.11 |
| type flavor (Product code: | Ingredients | |
| 300417L) | | |
| Annatto color | Sensient | 0.04 |

A person of ordinary skill in the art has the ability to use the preceding formulations to produce a non-dairy cheese sauce of the desired type through refinement of the relative percentages of the formulation reported herein.

1. A non-dairy cheese product composition, wherein the quantity of crude protein in the non-dairy cheese product composition is at least about 4 wt. % and wherein the non-dairy cheese product composition comprises an inactive yeast source, wherein the quantity of the inactive yeast source in the non-dairy cheese product composition is at least about 5 wt. %.

2. The non-dairy cheese product composition according to claim 1, wherein the non-dairy cheese product composition comprises at least 1 g of crude protein per 28 g serving.

3. The non-dairy cheese product composition according to claim 1, wherein the inactive yeast source is selected from brewer's yeast, dried yeast, torula yeast, yeast extracts, autolyzed yeast, and yeast cultivated on a substrate, and combinations thereof.

4. The non-dairy cheese product composition according to claim 1, wherein the non-dairy cheese product composition is a vegan non-dairy cheese product composition.

5. The non-dairy cheese product composition according to claim 1, wherein the non-dairy cheese product composition comprises an oil source or a combination of oil sources, wherein the quantity of the oil source or the combination of oil sources in the non-dairy cheese product composition is at least about 15 wt. %.

6. The non-dairy cheese product composition according to claim 1, wherein the non-dairy cheese product composition comprises a polysaccharide source or a combination of polysaccharide sources, wherein the quantity of the polysaccharide source or the combination of polysaccharide sources in the non-dairy cheese product composition is at least about 5 wt. %.

7. The non-dairy cheese product composition according to claim 1, wherein the non-dairy cheese product composition comprises a plant and/or a microbial protein concentrate or isolate, wherein the quantity of the plant and/or the microbial protein concentrate or isolate in the non-dairy cheese product composition is between about 0.0 wt. % and 10.0 wt. %.

8. The non-dairy cheese product composition according to claim 1, wherein the protein content of the plant and/or the microbial protein concentrate or isolate is at least 50% crude protein by weight of the plant and/or the microbial protein concentrate or isolate

9. The non-dairy cheese product composition according to claim 1, wherein the inactive yeast source is a source of crude protein in the non-dairy cheese product composition, and/or wherein the inactive yeast source increases the protein content in the non-dairy cheese product by facilitating the inclusion of the plant and/or the microbial protein concentrate or isolate.

10. The non-dairy cheese product composition according to claim 1, wherein the non-dairy cheese product composition comprises a flavoring or a combination of flavorings.

11. The non-dairy cheese product composition according to claim 1, wherein the non-dairy cheese product composition comprises a coloring or a combination of colorings.

12. The non-dairy cheese product composition according to claim 1, comprising:
(i) water and/or a plant-based milk;
(ii) an oil source;
(iii) a polysaccharide source;
(iv) an inactive yeast source;
(v) optionally, a plant and/or a microbial protein concentrate or isolate;
(vi) a flavoring or a combination of flavorings and
(vii) a coloring or a combination of colorings.

13. The non-dairy cheese product composition according to claim 1, comprising:
(i) water and/or a plant-based milk, wherein the quantity of the water and/or the plant-based milk is between about 25 wt. % and 50 wt. %;
(ii) an oil source, wherein the quantity of the oil source is between about 15 wt. % and 40 wt. %;
(iii) a polysaccharide source, wherein the quantity of the polysaccharide source is between about 5 wt. % and 30 wt. %;
(iv) an inactive yeast source, wherein the quantity of the inactive yeast source is between about 5 wt. % and 25 wt. %;
(v) optionally, a plant and/or a microbial protein concentrate or isolate, wherein the quantity of the plant and/or the microbial protein concentrate or isolate is between about 0.00 wt. % and 10.00 wt. %;
(vi) a flavoring or a combination of flavorings, wherein the quantity of the flavoring or the combination of flavorings is between about 0.00 wt. % and 5.00 wt. %, and
(vii) a coloring or a combination of colorings, wherein the quantity of the coloring or a combination of colorings is between about 0.00 wt. % and 2.00 wt. %.

14. A non-dairy cheese product, obtainable from a non-dairy cheese product composition according to claim 1, wherein the non-dairy cheese product is a hard or a semi-hard cheese or wherein the non-dairy cheese product is a non-dairy cheese sauce.

15. Use of an inactive yeast source in a non-dairy cheese product composition, wherein the quantity of the inactive yeast source in the non-dairy cheese product composition is at least about 5 wt. % to increase the protein content in the non-dairy cheese product by facilitating the inclusion of a plant and/or a microbial protein concentrate or isolate in the non-dairy cheese product composition.

16. The non-dairy cheese product composition according to claim 1, wherein the non-dairy cheese product composition comprises an oil source selected from coconut oil, sunflower oil, rapeseed oil and combinations thereof.

17. The non-dairy cheese product composition according to claim 1, wherein the non-dairy cheese product composition comprises a polysaccharide source selected from a chain of galactose moieties or a chain of mannose moieties; modified potato starch; modified corn starch; tapioca flour; modified sago starch; potato starch; locust bean gum; xanthan gum; and combinations thereof.

18. The non-dairy cheese product composition according to claim 1, wherein the non-dairy cheese product composition comprises a plant and/or a microbial protein concentrate or isolate selected from a soy protein concentrate, a soy protein isolate, a pea protein isolate, a chickpea concentrate, mycoprotein, and combinations thereof.

19. The non-dairy cheese product composition according to claim 1, wherein the non-dairy cheese product composition comprises a flavoring or a combination of flavorings selected from a salt, a cheese flavoring, a dairy type flavor enhancer, lactic acid, and combinations thereof.

20. The non-dairy cheese product composition according to claim 1, wherein the non-dairy cheese product composition comprises a coloring or a combination of colorings selected from annatto, paprika and combinations thereof.
